(19) United States
(12) Patent Application Publication
(10) Pub. No.: US 2004/0164528 A1
(43) Pub. Date: Aug. 26, 2004

(54) Safety system for occupants of a motor vehicle

(76) Inventors: Herbert Boegge, Wiemsheim (DE); Alfons Maesing, Muehlacker-Enzberg (DE); Leo Linder, Voehringen (DE); Frank Mueller, Leonberg (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/729,378

(22) Filed: Dec. 8, 2003

(30) Foreign Application Priority Data
Dec. 7, 2002 (DE) 102 57 249.6

(51) Int. Cl. B60R 21/22

(52) U.S. Cl. 280/730.2

(57) ABSTRACT

A safety system intended for an occupant of a motor vehicle is in the form of a protective bag which can be filled with gas. In a moved-in condition, the bag is folded together in a packet and, in an inflated condition, the bag extends along an interior side of a side window in order to protect a head region of an adjacent sitting occupant against an impact. To improve functioning of the safety device and reduce a space requirement, the packet is fully immersed in a door body of the door, and the protective bag unfolds during inflation from the door body, in a direction of a roof, essentially along the door window.

This application claims the priority of German application 102 57 249.6, filed Dec. 7, 2002, the disclosure of which is expressly incorporated by reference herein.

Cross-reference is hereby made to commonly assigned U.S. patent application Ser. No. ______, titled MOTOR VEHICLE WITH A BODY STRUCTURE AND WITH A SIDE IMPACT PROTECTION DEVICE, filed ______, naming as inventors two of the four inventors named in the present application.

### BACKGROUND AND SUMMARY OF THE INVENTION

The present invention relates to a safety system for occupants of a motor vehicle in the form of a protective bag which can be filled with gas. In a moved-in condition, the bag is folded together in a packet, and in an inflated condition, the bag extends along an interior side of a door window of a vehicle body door in order to protect a head region of an adjacent sitting occupant against an impact.

A safety system of the initially mentioned type, known from U.S. Pat. No. 5,333,899, comprises a lower air bag mounted on a door and an upper air bag mounted on a lateral roof frame. When they are filled with a medium, the air bags cooperate in a form-locking manner by way of corresponding shaped sections. The two air bags have a relatively large volume which extends in the direction of the occupants and requires a relatively large space.

German Patent Document DE 200 12 116 U1 discloses a protective cushion in a vehicle occupant compartment in the area of a side wall which is inflated by way of a gas pipe extending along an A-column and a roof frame. In this construction, the protective cushion is inflated from the direction of the above-mentioned gas line, specifically in the downward direction.

It is an object of the invention to design a protective cushion of a safety system such that its protective cushion, which functions well, and its other components are accommodated in a door in a manner which is advantageous with respect to space.

According to the invention, this object is achieved by having the packet arranged to be fully immersed in a door body of the door, and by having the protective bag unfold during inflation from the door body in a direction of a roof essentially along the door window. Additional characteristics further developing the invention are set forth in dependent claims. A safety system operating process is also claimed.

Principal advantages achieved by the invention are that the air bag is designed such that, in the inflated condition, it extends approximately at a parallel distance from the side window of the door, specifically with a relatively small volume extending in the direction of the occupants. In this case, the air bag has a defined inherent stability which is achieved by way of sections worked into it. The fact that, during inflation, the air bag emerges by way of a door covering promotes not only a functionally appropriate inflating operation but also facilities a spatially favorable housing of the air bag. This also applies when the air bag forms a constructional unit with a gas lance, which constructional unit is fastened to an assembly carrier in the door body, and when a gas generator is housed adjacent to the above-mentioned constructional unit in the door body.

An embodiment of the invention is illustrated in the drawing and will be described in detail.

### BRIEF DESCRIPTION OF THE DRAWINGS

FIG. 1 is a cross-sectional view of a body of a motor vehicle with a safety system according to the invention;

FIG. 2 is a view in the direction of the arrow A in FIG. 1;

FIG. 3 is a sectional view along line III-III of FIG. 2; and

FIG. 4 is a schematic sectional view along line IV-IV of FIG. 2.

### DETAILED DESCRIPTION OF THE INVENTION

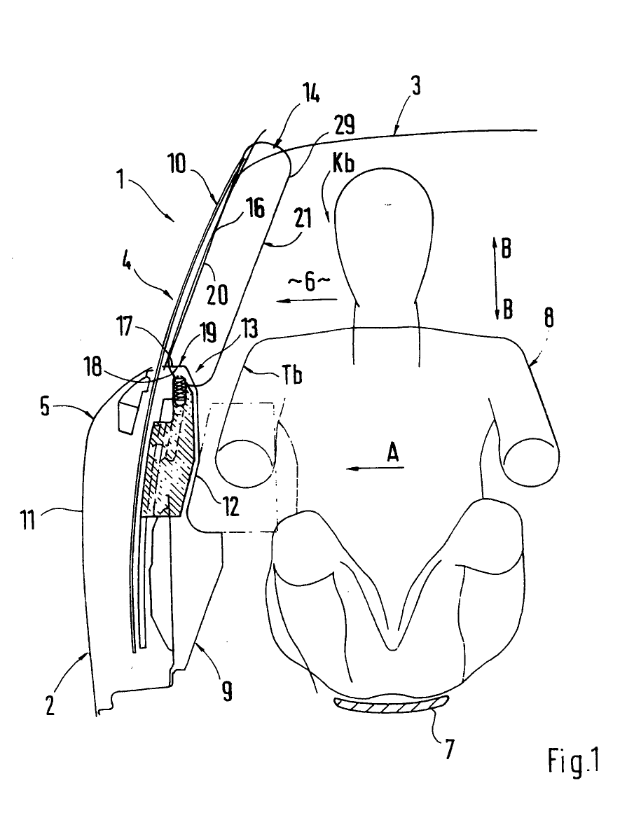

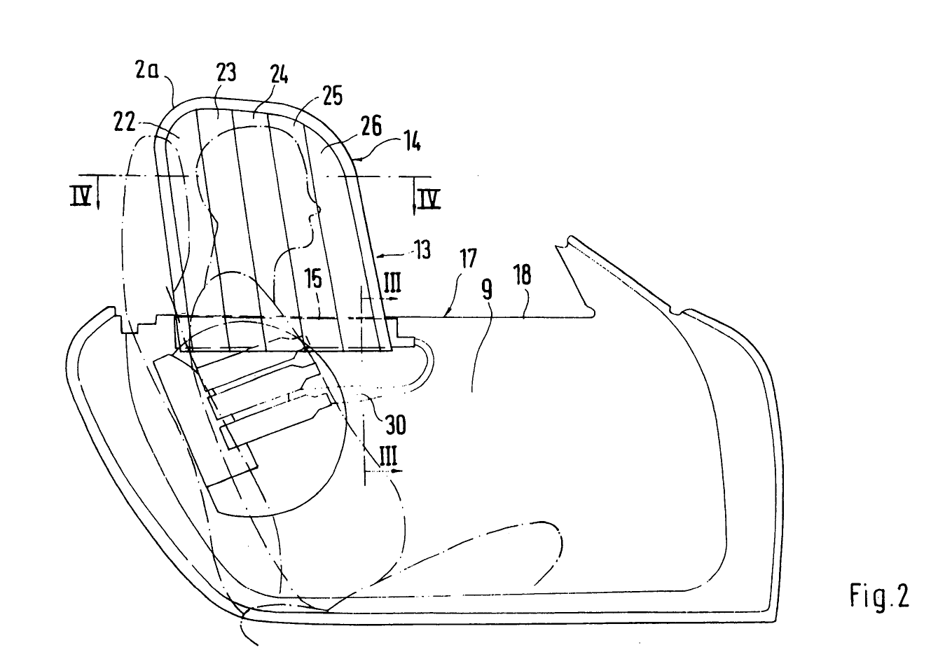

A motor vehicle 1 comprises a vehicle body 2 having a roof 3 and a side wall in which a door 5 is inserted—FIG. 1—. The door 5 bounds a vehicle occupant compartment 6 for at least one occupant 8 resting in a seat 7 and has a door body 9 and a door window 10 which is constructed in an immersible fashion in the above-mentioned door body 9. The door body 9 is formed by an exterior wall 11 and an interior frame 12 extending in the vehicle occupant compartment 6 and is provided with a safety system 13 for the occupant 8. The safety system 13 is used mainly for the protection of the occupant's thorax region Tb or head region Kb and operates like a passive safety system known in the vehicle construction field as an air bag. Under the influence of a vehicle collision, a pyrotechnical fuel is ignited, whereby a folded protective bag is inflated within fractions of a second. The safety system 13 has a protective bag 14 which, in the moved-in condition Ze, is folded together as a packet which is fully immersed in the door body 9 and, in the inflated condition Za—FIGS. 1 and 2—extends along an interior side 16 of the door window 10.

For this purpose, during unfolding, the protective bag 14 emerges from the door body 9 by way of a door covering 19 extending adjacent to a belt line 17 or a door elbow place 18, in order to move in the direction of the roof 3. The protective bag 14 is dimensioned and designed such that, in the inflated condition Za, it rests, on the one side, by means of a first wall 20 against the interior side 16 of the door window 10 and, on the other side, by means of a second wall 21 facing away from this door window 10 or facing the occupant 8, extends at an approximately equal distance and/or parallel to the door window 10 or the first wall 20—FIGS. 1 and 4—. Furthermore, the air bag 14 has several hollow-body-type sections 22, 23, 24, 25, 26 —FIGS. 2 and 4—which provide the air bag 14 with a defined inherent stability in the inflated condition Za and which, in the embodiment, have an approximately identical cross-section. In addition, the hollow-body-type sections 22, 23, 24, 25 and 26 extend at the same distance from one another, specifically in the vertical direction of the vehicle.

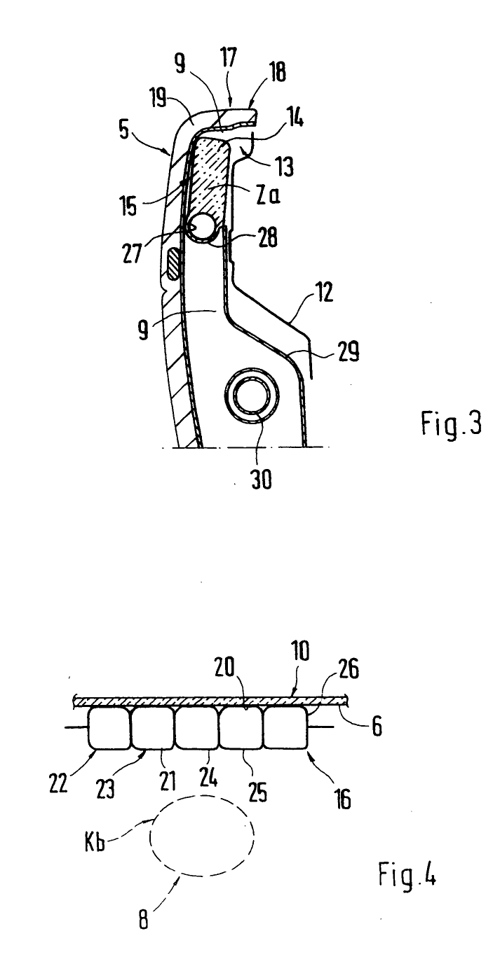

According to FIGS. 2 and 3, the packet 15 and the gas lance 27 form a constructional unit 28 within the door body 9, which constructional unit 28 is fastened to an assembly carrier 29 extending adjacent to the interior frame 12—FIG. 3—. Finally, a gas generator 30 of the safety system 13 is also housed in the door body 9, which gas generator 30 can also be mounted on the interior frame 12.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

We claim:

1. A safety system for a motor vehicle in the form of a protective bag which can be filled with gas and which, in a moved-in condition, is folded together in a packet and, in an inflated condition, extends along an interior side of a door window of a door of a vehicle body in order to protect a head region of an adjacent sitting occupant against an impact, wherein the packet is arranged to be fully immersed in a door body of the door, and wherein the protective bag unfolds during inflation from the door body in a direction of a roof essentially along the door window.

2. The safety system according to claim 1, wherein the protective bag is constructed such that a wall of the protective bag facing away from the door window, in the inflated condition, extends approximately parallel to the door window.

3. The safety system according to claim 1, wherein the protective bag has several hollow-body-type sections which, in the inflated condition, provide the protective bag with a defined inherent stability.

4. The safety system according to claim 3, wherein the hollow-body-type sections of the protective bag are constructed approximately with the same cross-section.

5. The safety system according to claim 4, wherein the hollow-body-type sections extend at an identical distance from one another in the vertical direction of the vehicle.

6. The safety system according to claim 1, wherein the protective bag emerges by way of a door covering during inflation.

7. The safety system according to claim 6, wherein the packet forms a constructional unit together with a gas lance.

8. The safety system according to claim 7, wherein the constructional unit is fastened to an assembly carrier in the door body.

9. The safety system according to claim 8, wherein a gas generator is housed adjacent to the constructional unit in the door body.

10. The safety system according to claim 6, wherein the protective bag emerges adjacent to a belt line.

11. A process of operating a safety system for a motor vehicle comprising filling, with gas, a protective bag which, in a moved-in condition, is folded together in a packet arranged to be fully immersed in a door body of a door of a vehicle body so that the protective bag unfolds during inflation from the door body in a direction of a roof essentially along a door window and extends along an interior side of the door window in order to protect a head region of an adjacent sitting occupant against an impact in an inflated condition.

12. A motor vehicle comprising:
a vehicle body having a door and a door window of the door, and
a safety system in the form of a protective bag which can be filled with gas and which, in a moved-in condition, is folded together in a packet and, in an inflated condition, extends along an interior side of the door window of the door of the vehicle body in order to protect a head region of an adjacent sitting occupant against an impact,
wherein the packet is arranged to be fully immersed in a door body of the door, and
wherein the protective bag unfolds during inflation from the door body in a direction of a roof essentially along the door window.

13. The motor vehicle according to claim 12, wherein the protective bag is constructed such that a wall of the protective bag facing away from the door window, in the inflated condition, extends approximately parallel to the door window.

14. The motor vehicle according to claim 12, wherein the protective bag has several hollow-body-type sections which, in the inflated condition, provide the protective bag with a defined inherent stability.

15. The motor vehicle according to claim 14, wherein the hollow-body-type sections of the protective bag are constructed approximately with the same cross-section.

16. The motor vehicle according to claim 15, wherein the hollow-body-type sections extend at an identical distance from one another in the vertical direction of the vehicle.

17. The motor vehicle according to claim 12, wherein the protective bag emerges by way of a door covering during inflation.

18. The motor vehicle according to claim 17, wherein the packet forms a constructional unit together with a gas lance.

19. The motor vehicle according to claim 18, wherein the constructional unit is fastened to an assembly carrier in the door body.

20. The motor vehicle according to claim 19, wherein a gas generator is housed adjacent to the constructional unit in the door body.

21. The motor vehicle according to claim 17, wherein the protective bag emerges adjacent to a belt line.
